(19) United States
(12) Patent Application Publication
(10) Pub. No.: US 2012/0002028 A1
(43) Pub. Date: Jan. 5, 2012

(54) FACE IMAGE PICK-UP APPARATUS FOR VEHICLE

(75) Inventors: Akio Takahashi, Shioya-gun (JP); Shinsuke Ueda, Utsunomiya-shi (JP); Seiichi Yamamoto, Utsunomiya-shi (JP)

(73) Assignee: HONDA MOTOR CO., LTD., Tokyo (JP)

(21) Appl. No.: 13/175,433

(22) Filed: Jul. 1, 2011

(30) Foreign Application Priority Data
Jul. 5, 2010 (JP) 2010-153021
Jul. 5, 2010 (JP) 2010-153022

(51) Int. Cl. H04N 7/18

(52) U.S. Cl. 348/78; 348/E07.085

(57) ABSTRACT

There is provided a face image pick-up apparatus for a vehicle including an image pick-up unit installed in a vehicle having a steering wheel disposed in front of a driver's seat of a vehicle interior and a tilt mechanism adjusting a tilt angle with respect to a vertical direction of the steering wheel to image a face image of a driver seated on the driver's seat, wherein the image pick-up unit is disposed vertically above a central axis line of the steering wheel and vertically above the upper end of the steering wheel when the steering wheel is displaced to the upper limit position by the tilt mechanism, when viewing the steering wheel from the front.

### BACKGROUND OF THE INVENTION

1. Field of the Invention

The present invention relates to a vehicle-mounted face image pick-up apparatus for a vehicle which images a face image of a driver for detecting the direction of the driver's face or gaze, or the like.

Priorities are claimed on Japanese Patent Application No. 2010-153021 filed on Jul. 5, 2010 and Japanese Patent Application No. 2010-153022 filed on Jul. 5, 2010, the contents of which are incorporated herein by reference.

2. Description of the Related Art

As an apparatus for recognizing a behavior of a driver while driving, a vehicle in which a face image pick-up apparatus is mounted is known. The face image pick-up apparatus images the face of a driver who is seated on a driver's seat through an image pick-up unit such as a CCD camera, or the like and detects the face direction, the gaze direction, or the like, of the driver by analyzing the imaged image (for example, see Japanese Unexamined Patent Application, First Publication No. 2007-69680).

In the face image pick-up apparatus described in Japanese Unexamined Patent Application, First Publication No. 2007-69680, the camera that is the image pick-up unit and the infrared projector are integrated as a camera assembly, wherein the camera assembly is attached to a steering column having a tilt mechanism. In the face image pick-up apparatus, since the camera assembly integrally moves while being interlocked with the steering column, the face image of the driver can be imaged by projection into the driver by the projector and the camera through openings between spokes of a steering wheel even when a tilted angle in a vertical direction of the steering wheel is adjusted by the operation of the tilt mechanism.

However, in the face image pick-up apparatus according to the related art, since the camera images the face of the driver through the openings between the spokes of the steering wheel, there interruptions may occur between the camera and the face of the driver due to the arm of the driver or the steering wheel when the driver steers the steering wheel, or the like. In this case, it is not likely to appropriately image the face of the driver.

Further, since the face image pick-up apparatus according to the related art has a configuration in which the camera assembly changes the tilted angle in the vertical direction by the operation of the tilt mechanism, the position of the camera in regard to the openings between the spokes of the steering wheel is appropriately maintained. However, the camera may not appropriately direct the position of the face of the driver in response to the tilt angle, such that a case in which the image direction of the camera is directed in an inappropriate direction may occur.

As a method for solving the above problem, a method for fixedly installing a camera somewhere between a driver's seat and a passenger's seat can be considered. In this case, however, there are problems in that the appearance of the installed camera make a viewer feel uncomfortable, obstructs the driver's field of vision, and the camera has difficulty appropriately imaging the face of the driver, in particular, both eyes of the driver from the front.

Further, in the face image pick-up apparatus according to the related art, since the image pick-up unit, that is, the camera and the infrared projector are disposed to be close to each other as a camera assembly, when light projected from the projector is reflected from both of the glasses and the eyeballs of the driver in a case in which the driver wears glasses, two bright spots generated by the reflection may overlap each other when being viewed from the camera. As such, when the bright spots on the glasses overlap the bright spots on the eyeballs, it is not possible to appropriately image the bright spots on the eyeballs, such that there is a risk that it will not be possible to accurately detect the gaze direction of the driver.

### SUMMARY OF THE INVENTION

In this case, the present invention is to provide a face image pick-up apparatus for a vehicle capable of appropriately imaging the face of a driver from the front at all times, regardless of an angle adjustment of a vertical direction of a steering wheel using a tilt mechanism. Furthermore, the present invention is to provide a face image pick-up apparatus for a vehicle capable of accurately imaging bright spots on the eyeballs of a driver by an image pick-up unit, even in a case the driver wears glasses.

A face image pick-up apparatus according to the present invention includes the following units so as to solve the above problems.

(1) According to a first embodiment of the present invention, there is provided a face image pick-up apparatus for a vehicle including an image pick-up unit installed in a vehicle having a steering wheel disposed in front of a driver's seat of a vehicle interior and a tilt mechanism adjusting a tilt angle with respect to a vertical direction of the steering wheel to image a face image of a driver seated on the driver's seat, wherein the image pick-up unit is disposed vertically above a central axis line of the steering wheel and vertically above an upper end of the steering wheel when the steering wheel is displaced to the upper limit position by the tilt mechanism, when viewing the steering wheel from the front.

(2) The face image pick-up apparatus for a vehicle described in the above (1) may include a projection unit projecting visible light or non-visible light to the driver, wherein the projection unit may be disposed at a position at which the projection unit does not overlap the movable range of the arm of the driver operating the steering wheel and at the positions that are the side in a vehicle width direction of the central axis line of the steering wheel and an outer side of the steering wheel, when viewing the steering wheel from the front.

(3) According to a second embodiment of the present invention, there is provided a face image pick-up apparatus for a vehicle, including: an image pick-up unit that is installed in a vehicle having a steering wheel disposed in front of a driver's seat of a vehicle interior and a tilt mechanism adjusting a tilt angle with respect to a vertical direction of the steering wheel to image a face image of a driver seated on the driver's seat; and a projection unit that projects visible light or non-visible light into the eyeballs of the driver, wherein the image pick-up unit and the projection unit are disposed to be spaced apart from each other by a predetermined distance in a vertical direction and a vehicle width direction, respectively; the predetermined distance is set to be a distance at which bright spots on glasses generated by reflecting the visible light or the non-visible light from the glasses worn by the driver and bright spots on the eyeballs generated by reflecting the visible light or the non-visible light projected by the projection unit from the eyeballs of the driver do not overlap each other when being viewed from the image pick-up unit.

(4) In the face image pick-up apparatus for a vehicle apparatus, the projection unit may be disposed vertically above the image pick-up unit when the projection unit is disposed vertically above the eyeball position of the driver seated on the driver's seat and is disposed vertically under the image pick-up unit when the projection unit is disposed vertically under the eyeball position.

According to the face image pick-up apparatus for a vehicle described in the above (1), since the image pick-up unit is always disposed vertically above the upper end of the steering wheel regardless of the adjusted position of the steering wheel using the tilt mechanism, when viewing the steering wheel from the front, it is possible to prevent the interruption between the image pick-up unit and the face of the driver due to the arm of the driver or the steering wheel itself at the time of steering the steering wheel, or the like. Further, since the image pick-up unit is disposed vertically above the central axis line of the steering wheel when viewing the steering wheel from the front, it is possible to more appropriately image the face of the driver from the front.

In the case of the above (2), since the projection unit is disposed at the position at which the projection unit does not overlap the movable range of the arm of the driver and at the positions that are the side in the vehicle width direction of the central axis line of the steering wheel and the outer side of the steering wheel, when viewing the steering wheel from the front, it is possible to prevent the interruption between the projection unit and the face of the driver due to the arm of the driver or the steering wheel itself.

According to the face image pick-up apparatus for a vehicle described in the above (3), since the image pick-up unit and the projection unit are disposed to be spaced apart from each other by a predetermined distance or more in the vertical direction and the vehicle width direction, respectively, so that the bright spots on the glasses and the bright spots on the eyeballs do not overlap each other even when the driver wears glasses, when being viewed from the image pick-up unit, it is possible to more reliably detect the bright spots on the eyeballs of the driver without undergoing an adverse affect due to the bright spots on the glasses.

Further, since the image pick-up unit and the projection unit are spaced apart from each other by the predetermined distance or more in both directions of the vertical direction and the vehicle width direction, it is possible to reliably prevent the bright spots on the glasses and the bright spots on the eyeballs that are viewed from the image pick-up unit from overlapping each other even when the face of the driver is tilted in either of the vertical direction and the horizontal direction with respect to the front of the vehicle.

In the case of the above (4), when the image pick-up unit is disposed vertically above the position of the eyeballs of the driver, the projection unit is disposed vertically above the image pick-up unit. Meanwhile, when the image pick-up unit is disposed vertically lower than the position of the eyeballs of the driver, the projection unit is disposed vertically under the image pick-up unit. Therefore, the bright spots on the glasses and the bright spots on the eyeballs can be appropriately spaced apart from each other in the vertical direction.

### BRIEF DESCRIPTION OF THE DRAWINGS

FIG. 1 is a schematic side view of a vehicle interior showing a schematic configuration of a face image pick-up apparatus according to a first embodiment of the present invention.

FIG. 2 is a front view showing a vehicle interior in which the face image pick-up apparatus according to the first embodiment of the present invention is installed.

FIG. 3 is a schematic side view of a vehicle interior showing a schematic configuration of a face image pick-up apparatus according to a second embodiment of the present invention.

FIG. 4 is a front view showing a vehicle interior in which the face image pick-up apparatus according to the second embodiment of the present invention is installed.

FIG. 5 is a diagram showing a face image imaged by the image face pick-up apparatus according to the second embodiment of the present invention.

FIG. 6 is a schematic side view showing a range in which a projector according to the second embodiment of the present invention cannot be disposed.

FIG. 7 is a schematic side view of a vehicle interior showing a schematic configuration of a face image pick-up apparatus according to a third embodiment of the present invention.

FIG. 8 is a front view showing a vehicle interior in which the face image pick-up apparatus according to the third embodiment of the present invention is installed.

FIG. 9 is a diagram showing a face image imaged by the image face pick-up apparatus according to the third embodiment of the present invention.

### DETAILED DESCRIPTION OF THE INVENTION

### First Embodiment

Hereinafter, a first embodiment of the present invention will be described with reference to the accompanying drawings.

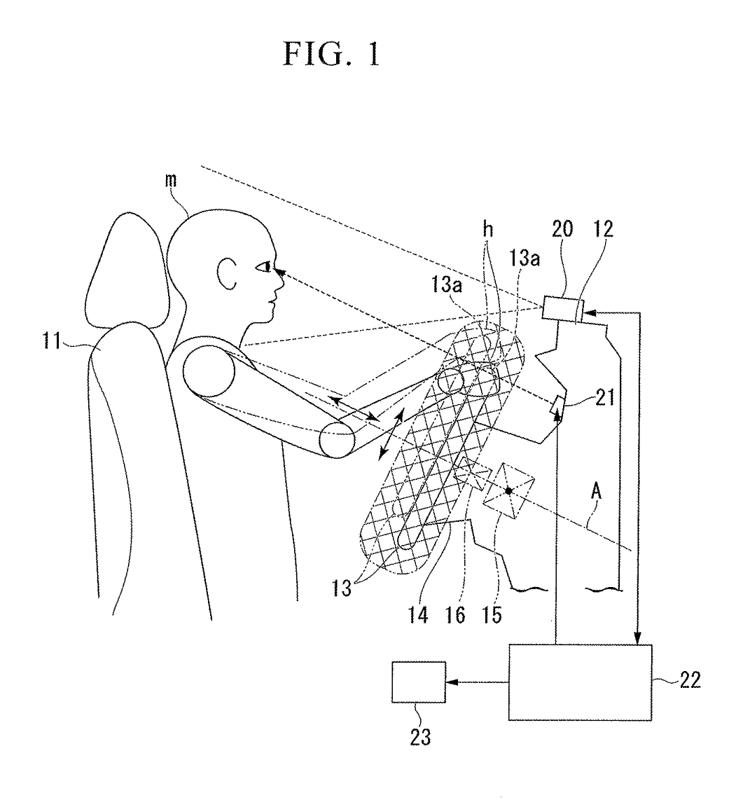

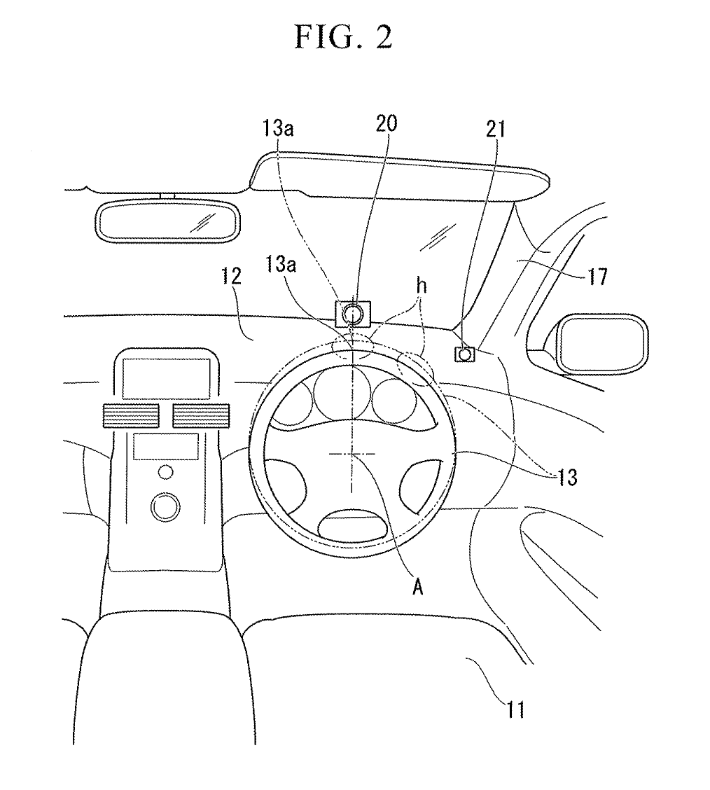

FIG. 1 shows a configuration of a face image pick-up apparatus 1 according to the first embodiment and FIG. 2 shows a vehicle interior in which the face image pick-up apparatus 1 is installed.

In FIGS. 1 and 2, reference numeral 11 is a driver's seat on which a driver m is seated, reference numeral 12 is an installation panel installed on the front of the driver's seat, reference numeral 13 is a steering wheel, and reference numeral 14 is a steering column supporting a steering shaft (not shown).

The steering wheel 13 can adjust a tilted angle in a vertical direction using a tilt mechanism 15 installed on the steering column 14 and can adjust a position in a longitudinal direction using a telescopic mechanism 16 installed on the steering shaft. In FIG. 1, the range shown by a mesh is the schematic movable range of the steering wheel 13 by the tilt mechanism 15 and the telescopic mechanism 16.

The face image pick-up apparatus 1 includes a CCD camera 20 that is an image pick-up unit imaging the face of the driver m, a near-infrared LED 21 that is a projection unit irradiating light to the eyeballs of the driver m, and a control device 22 that controls the CCD camera 20 and the near-infrared LED 21 and performs image processing and analysis based on a detection signal of the CCD camera 20. Results of performing the image processing and the analysis by the control device 22 are used in, for example, an inattentive alarm device and the control device 22 operates an alarm unit 23 when it is determined that the driver m is not looking at the road. The projection unit is not limited to the near-infrared LED 21 and any projection unit may be used, as long as the projection unit is a point light source irradiating visible light or non-visible light to the eyeballs of a passenger.

In the image processing and the analysis in the face image pick-up apparatus 1, for example, it detects a face direction of the driver m based on the face image of the driver m, detects a position of a reflection point (the bright spots on the eyeballs) at an iris when irradiating light to the eyeballs of the driver m from the near-infrared LED 21, and detects a position of a pupils, and then obtains the gaze direction of the driver m based on the distance between the reflection point at the iris and the pupils.

In the face image pick-up apparatus 1, the CCD camera 20 is installed on, for example, the top surface of the installation panel 12 so that the CCD camera 20 is disposed vertically above the central axis line A of the steering wheel 13 and is disposed above the upper end 13a of the steering wheel 13 even when the position of the steering wheel 13 is adjusted to a maximum rising position (upper limit position) by the tilt mechanism 15 or the telescopic mechanism 16, when viewing the steering wheel 13 from the front.

The preferable installation height of the CCD camera 20 is a height that is above a hand h of the driver m, even when the hand h of the driver m rotatably operating the steering wheel 13 reaches the upper end 13a of the steering wheel 13 in the state in which the position of the steering wheel 13 is adjusted to the maximum rising position.

Further, in the face image pick-up apparatus 1, the near-infrared LED 21 is installed on the portion of installation panel 12 which is adjacent to a base part of a front pillar 17 in front of the driver's seat 11. The installation position of the near-infrared LED 21 is a position at which the near-infrared LED 21 does not overlap the arm of the driver m rotatably operating the steering wheel 13 and positions that are the side in a vehicle width direction of a central axis line A of the steering wheel 13 and an outer side of the steering wheel 13, when viewing the steering wheel 13 from the front.

As described above, the face image pick-up apparatus 1 is disposed vertically above the central axis line A and vertically above the upper end 13a of the steering wheel 13 even when the steering wheel 13 is displaced to the upper limit position by the tilt mechanism 15 or the telescopic mechanism 16, when viewing the steering wheel 13 from the front. Therefore, it is possible to prevent the interruption between the CCD camera 20 and the face of the driver m due to the arm of the driver m or the steering wheel 13 at the time of steering the steering wheel 13, or the like, regardless of the adjusted position of the steering wheel 13.

Further, in the face image pick-up apparatus 1, since the CCD camera 20 is disposed vertically above the central axis line A of the steering wheel 13 when viewing the steering wheel 13 from the front, it is possible to appropriately photograph the face of the driver m, in particular, both eyes of the driver m from the front.

Further, in the face image pick-up apparatus 1, the near-infrared LED 21 is disposed at a position at which the near-infrared LED 21 does not overlap the arm of the driver m rotatably operating the steering wheel 13 and at positions that are the side in a vehicle width direction of a central axis line A of the steering wheel 13 and the outer side of the steering wheel, when viewing the steering wheel 13 from the front. Therefore, it is possible to prevent the interruption between the near-infrared LED 21 and the face (eyeballs) of the driver m due to the arm of the driver m or the steering wheel 13.

The present invention is not limited thereto the first embodiment, but the design thereof can be changed without departing from the subject matter. For example, in the first embodiment, although only one near-infrared LED 21 (a projection unit) is installed at the right of the steering wheel 13 toward the front of the driver's seat, the projection unit may be similarly installed to the right and left of the steering wheel 13.

### Second Embodiment

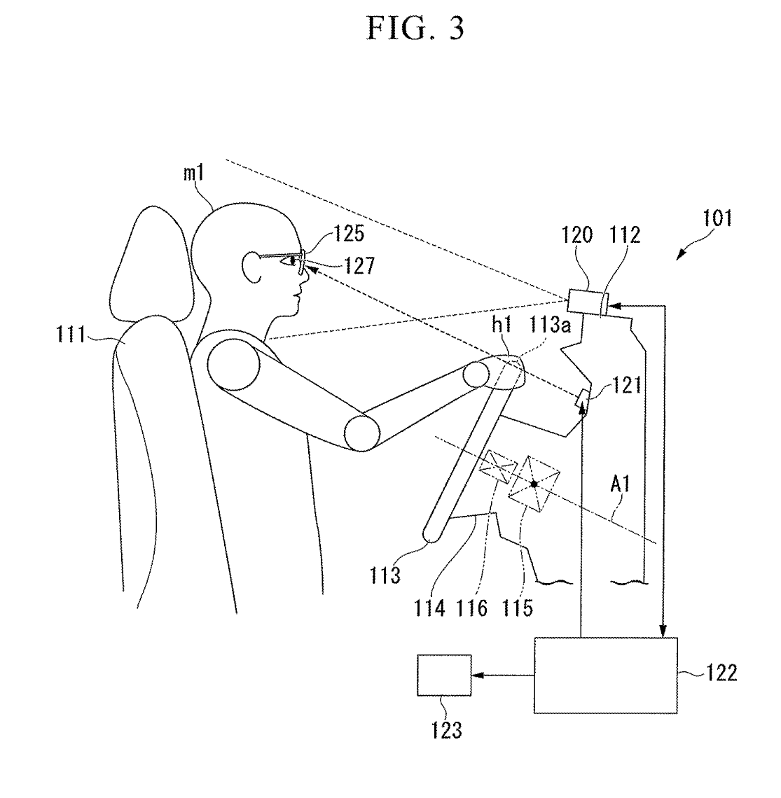

Next, a second embodiment of a face image pick-up apparatus of the present invention will be described with reference to FIGS. 3 to 6.

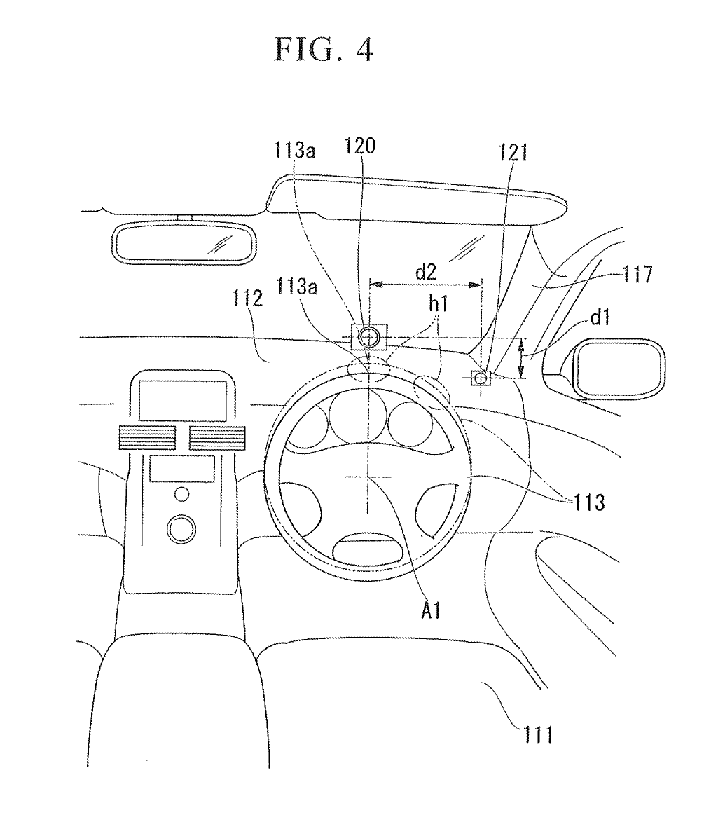

FIG. 3 shows a configuration of a face image pick-up apparatus 101 according to the second embodiment and FIG. 4 shows a vehicle interior in which the face image pick-up apparatus 101 is mounted.

In FIGS. 3 and 4, reference numeral 111 is a driver's seat on which a driver m1 is seated, reference numeral 112 is an installation panel installed on a front of the driver's seat, reference numeral 113 is a steering wheel, and reference numeral 114 is a steering column supporting a steering shaft (not shown).

The steering wheel 113 can adjust a tilted angle in a vertical direction using a tilt mechanism 115 installed on the steering column 114 and can adjust a position in a longitudinal direction using a telescopic mechanism 116 mounted on the steering shaft.

The face image pick-up apparatus 101 includes a CCD camera 120 that is an image pick-up unit imaging the face of the driver m1, a near-infrared LED 121 that is a projection unit irradiating light to the eyeballs 127 of the driver m1, and a control device 122 that controls the CCD camera 120 and the near-infrared LED 121 and performs image processing and analysis based on a detection signal of the CCE camera 120. Results of performing the image processing and the analysis by the control device 122 are used in, for example, an inattentive alarm device and the control device 22 operates an alarm unit 123 when it is determined that the driver m1 is not looking at the road. The projection unit is not limited to the near-infrared LED 121 any projection unit may be used if the projection unit is a point light source irradiating visible light or non-visible light to the eyeballs 127 of a passenger.

In the image processing and the analysis in the face image pick-up apparatus 101, for example, it detects a face direction of the driver m1 based on the face image of the driver m1, detects the positions of bright spots (the bright spots 128 on the eyeballs) at irises when irradiating light to the eyeballs 127 of the driver m1 from the near-infrared LED 121, and detects a position of a pupils, and then determines the gaze direction of the driver m1 based on the spacing distance between the bright spots at the iris and the pupils.

In the face image pick-up apparatus 101, the CCD camera 120 is installed on, for example, the top surface of the installation panel 112 so that the CCD camera 120 is disposed vertically above a central axis line A1 of the steering wheel 113 and is disposed above the upper end 113a of the steering wheel 13 when the position of the steering wheel 13 is adjusted to a maximum rising position (upper limit position) by the tilt mechanism 115 or the telescopic mechanism 116, when viewing the steering wheel 113 from the front.

The preferable installation height of the CCD camera 120 is a height that is above a hand h1 of the driver m, even when the hand h1 of the driver m1 rotatably operating the steering wheel 113 reaches the upper end 113a of the steering wheel 113 in the state in which the position of the steering wheel 113 is adjusted to the maximum rising position.

The near-infrared LED 121 of the face image pick-up apparatus 101 is installed on the portion of installation panel 112 which is adjacent to a base part of a front pillar 117 in front of the driver's seat. The installation position of the near-infrared LED 121 is a position at which the near-infrared LED 121 does not overlap the arm of the driver m1 rotatably operating the steering wheel 113 and at positions that are a side in a vehicle width direction of a central axis line A1 of the steering wheel 113 and an outer side of the steering wheel 113, when viewing the steering wheel 113 from the front. In the face image pick-up apparatus 101 of the second embodiment, when the position of the steering wheel 113 is adjusted to a standard position, the CCD camera 120 and the near-infrared LED 121 are disposed on a concentric circle, that is, at a position that is equidistant from the central axis line A1, based on the central axis line A of the steering wheel 1.

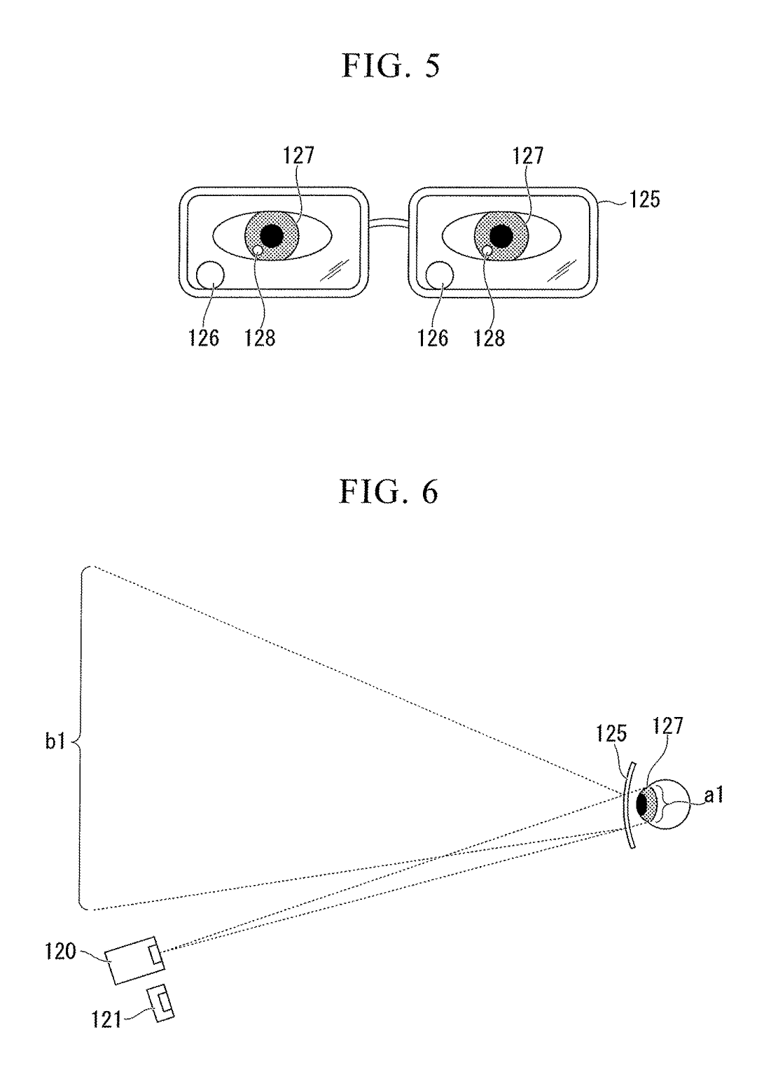

FIG. 5 shows the image imaged by the face image pick-up apparatus 101.

The CCD camera 120 and the near-infrared LED 121 are disposed to be spaced apart from each other by a predetermined distance or more in regard to the vertical direction and the vehicle width direction, as shown in FIGS. 3 and 4. In FIG. 4, reference numeral d1 represents a predetermined distance of the vertical direction, and reference numeral d2 represents a predetermined distance of the vehicle width direction. Each predetermined distance of the vertical direction and the vehicle width direction is a distance determined in consideration of a condition where the driver m1 wears glasses 125 and as shown in FIG. 5, is a distance at which bright spots 126 on glasses generated by reflecting the light projected from the near-infrared LED 121 on the glasses 125 and bright spots 128 on the eyeballs generated by reflecting the light projected from the near-infrared LED 121 at the irises of the eyeballs 127 do not overlap each other when being viewed from the CCD camera 120 (when imaged by the CCD camera 120). The preferable predetermined distance is a distance at which the bright spots 126 on the glasses do not overlap the bright spots 128 on the eyeballs, and also do not overlap the pupils on the eyeballs 127.

As shown in FIG. 3, in the case of the second embodiment, the CCD camera 120 that is the image pick-up unit is disposed vertically under the position of the eyeballs 127 of the driver m1 seated on the seat 111 and the near-infrared LED 121 that is the projection unit is disposed vertically lower than the CCD camera 120.

FIG. 6 is a diagram for explaining a reason why the case in which the near-infrared LED 121 is also disposed at a bottom side in a vertical direction and disposed at a lower position than the CCD camera 120 is advantageous when the CCD camera 120 is disposed vertically under the eyeballs 127 of the driver m1. In FIG. 6, a1 represents an imaging range when the CCD camera 120 images the iris region of the eyeballs 127 of the driver m1 and b1 represents a region on the glasses 125 alternating with the imaging range at that time and is a reflective glare range which the reflected image reflects into the CCD camera 120.

Therefore, when the near-infrared LED 121 is installed at the inner side of the reflective glare range b1, the image (the bright spots 128 on the eyeballs) of the near-infrared LED 121 on the eyeballs and the image (the bright spot 126 on the glasses) of the near-infrared LED 121 on the glasses 125 are highly likely to overlap each other and reflect into the CCD camera 120. However, in the second embodiment, since the near-infrared LED 121 is disposed vertically under the CCD camera 120, the image (the bright spots 126 on the glasses) of the near-infrared LED 121 on the glasses 125 will be reflected to an off position under the eyeballs 127 (the bright spots 128 on the eyeballs).

As described above, in the face image pick-up apparatus 101, the CCD camera 120 and the near-infrared LED 121 are disposed to be spaced apart from each other by a predetermined distance or more in the vertical direction and the vehicle width direction, respectively, so that the bright spots 126 on the glasses do not overlap with the bright spots 128 on the eyeballs and do not reflect into the CCD camera 120 even when the driver m1 wears the glasses 125. Therefore, it is possible to reliably detect the bright spots 128 on the eyeballs of the driver m1 without undergoing an adverse effect due to the bright spots 126 on the glasses.

In the face image pick-up apparatus 101, since the CCD camera 120 and the near-infrared LED 121 are disposed to be spaced apart from each other in the vertical direction and the vehicle width direction, respectively, it is possible to reliably prevent the reflection into the CCD camera 120 while the bright spots 126 on the glasses overlap the bright spots 128 on the eyeballs even when the face of the driver m1 is tilted to any one of the vertical direction and the horizontal direction with respect to the front of the vehicle.

Further, in the face image pick-up apparatus 101, since the near-infrared LED 121 is disposed at the position vertically lower than the CCD camera 120 under the condition in which the CCD camera 120 is disposed vertically under the position of the eyeballs 127 of the driver m1, the bright spots 126 on the glasses and the bright spots on the eyeballs reflected into the CCD camera 120 may be appropriately spaced apart from each other in the vertical direction.

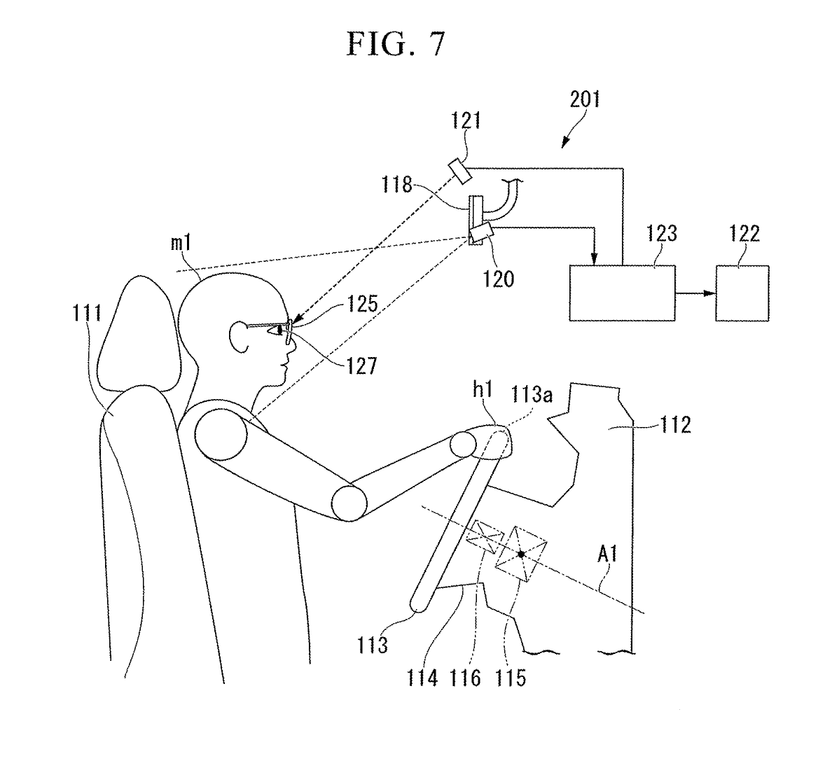

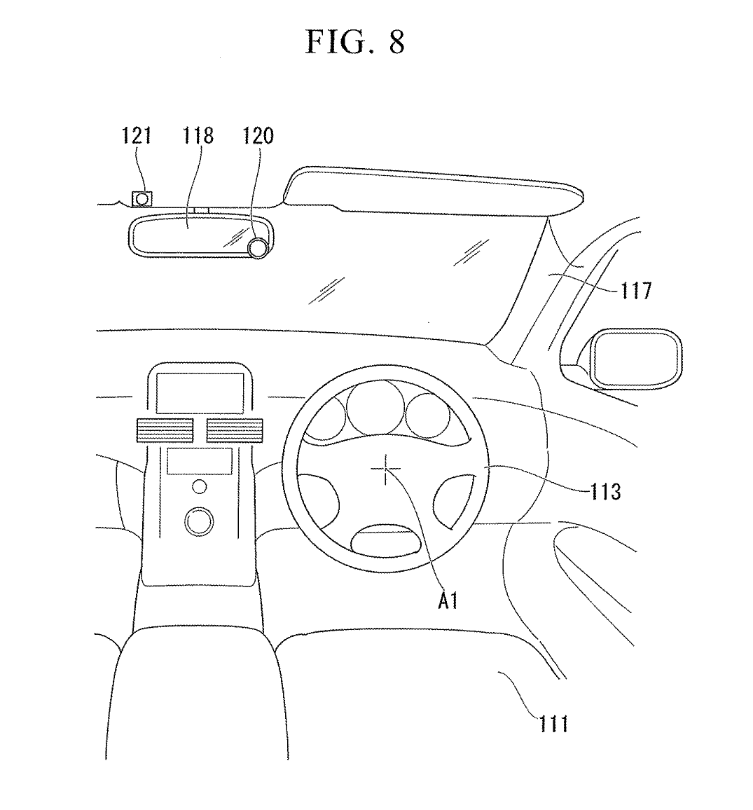

Subsequently, a third embodiment of the present invention will be described with reference to FIGS. 7 to 9.

The third embodiment and the second embodiment are only different in that the CCD camera 120 that is the image pick-up unit and the near-infrared LED 121 that is the projection unit are disposed on the vehicle and, in other respects, the configuration including the vehicle body is the same as the second embodiment. Therefore, the same components as the second embodiment are denoted by the same reference numerals and the repeated description thereof will be omitted.

In a face image pick-up apparatus 201, the CCD camera 120 is installed at a lower corner portion on the driver's seat side of a rear view mirror 118 in the vehicle interior and the near-infrared LED 121 is installed at a portion on the passenger's seat side rather than at a center in the vehicle width direction of a front end of a ceiling portion. In the third embodiment, although any one of the CCD camera 120 and the near-infrared LED 121 is installed at the position above the position of the eyeballs 127 of the driver m1, the near-infrared LED 121 is spaced apart from the CCD camera 120 by a predetermined distance or more in the vertical direction and the vehicle width direction, respectively.

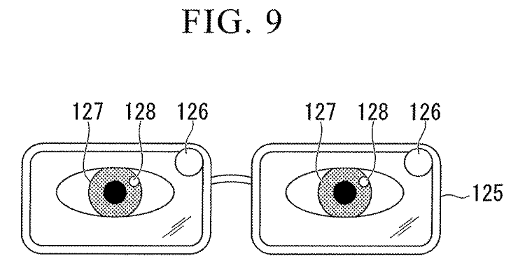

In this case, as shown in FIG. 9, the predetermined distance in each direction is a distance at which the bright spots 126 on glasses generated by reflecting the light projected from the near-infrared LED 121 on the glasses 125 and the bright spots 128 on the eyeballs generated by reflecting the light projected from the near-infrared LED 121 on the irises of the eyeballs 127 do not overlap each other when being viewed from the CCD camera 120 (when imaged by the CCD camera 120).

In the third embodiment, the CCD camera 120 that is the image pick-up unit is disposed vertically under the position of the eyeballs 127 of the driver m1 seated on the seat 111 and the near-infrared LED 121 that is the projection unit is disposed vertically higher than the CCD camera 120. Therefore, when the iris regions of the eyeballs 127 of the driver m1 are imaged from an oblique upper side by the CCD camera 120, the near-infrared LED 121 will not be reflected as a reflected image into the region in which alternating on the glasses 125 with the imaging range of the CCD camera. Thereby, as shown in FIG. 9, the image (the bright spots 126 on the glasses) of the near-infrared LED 121 on the glasses 125 imaged by the CCD camera 120 will be reflected to an off position above the eyeballs 127 (the bright spots 128 on the eyeballs).

Also in the third embodiment, it is possible to prevent the reflection into the CCD camera 120 while the bright spots 126 on the glasses overlap the bright spots 128 on the eyeballs. Furthermore, it is possible to more reliably prevent the bright spots 126 on the glasses and the bright spots 128 on the eyeballs from overlapping each other on the CCD camera 120 even when the face of the driver m1 is tilted to any one of the vertical direction and the horizontal direction with respect to the front of the vehicle.

Further, the present invention is not limited thereto the above embodiments, but the design thereof can be changed without departing from the subject matter. For example, in the above embodiments, although only one near-infrared LED 121 (the projection unit) is installed at the left and right of the steering wheel 113 toward the front of the driver seat, the projection unit may be similarly installed to the right and left of the steering wheel 113.

### DESCRIPTION OF THE REFERENCE SYMBOLS

1 . . . FACE IMAGE PICK-UP APPARATUS

11 . . . DRIVER'S SEAT

13 . . . STEERING WHEEL

13a . . . UPPER END

15 . . . TILT MECHANISM

20 . . . CCD CAMERA (IMAGE PICK-UP UNIT)

21 . . . NEAR-INFRARED LED (PROJECTION UNIT)

A . . . CENTRAL AXIS LINE

101, 201 . . . FACE IMAGE PICK-UP APPARATUS

113 . . . STEERING WHEEL

120 . . . CCD CAMERA (IMAGE PICK-UP UNIT)

121 . . . NEAR-INFRARED LED (PROJECTION UNIT)

126 . . . BRIGHT SPOT ON GLASSES

128 . . . BRIGHT SPOT ON EYEBALLS

d1 . . . PREDETERMINED DISTANCE OF THE VERTICAL DIRECTION

d2 . . . PREDETERMINED DISTANCE OF THE VEHICLE WIDTH DIRECTION

What is claimed is:

1. A face image pick-up apparatus for a vehicle comprising an image pick-up unit that is installed in a vehicle having a steering wheel disposed in front of a driver's seat of a vehicle interior and a tilt mechanism adjusting a tilt angle with respect to a vertical direction of the steering wheel, the image pick-up unit being disposed in front of the steering wheel in a vehicle length direction, to image a face image of a driver seated on the driver's seat,
wherein the image pick-up unit is disposed vertically above a central axis line of the steering wheel and vertically above an upper end of the steering wheel when the steering wheel is displaced to an upper limit position by the tilt mechanism, when viewing the steering wheel from the front.

2. The apparatus according to claim 1, further comprising a projection unit projecting visible light or non-visible light to the driver,
wherein the projection unit is disposed at a position at which the projection unit does not overlap the movable range of an arm of the driver operating the steering wheel and at the positions that are the side in a vehicle width direction of the central axis line of the steering wheel and an outer side of the steering wheel, when viewing the steering wheel from the front.

3. A face image pick-up apparatus for a vehicle, comprising:
an image pick-up unit that is installed in a vehicle to image a face image of a driver seated on the driver's seat; and
a projection unit that projects visible light or non-visible light into eyeballs of the driver,
wherein the image pick-up unit and the projection unit are disposed to be spaced apart from each other by a predetermined distance in a vertical direction and a vehicle width direction, respectively; and
the predetermined distance is set to be a distance at which bright spots on glasses generated by reflecting the visible light or the non-visible light from the glasses worn by the driver and bright spots on the eyeballs generated by reflecting the visible light or the non-visible light projected by the projection unit from the eyeballs of the driver do not overlap each other when being viewed from the image pick-up unit.

4. The apparatus according to claim 3, wherein the projection unit is disposed vertically above the image pick-up unit when the projection unit is disposed vertically above the eyeball position of the driver seated on the driver's seat and is disposed vertically under the image pick-up unit when the projection unit is disposed vertically under the eyeball position.
